(19) United States
(12) Patent Application Publication
(10) Pub. No.: US 2023/0088134 A1
(43) Pub. Date: Mar. 23, 2023

(54) OUTSOLE FORMED FROM SHEET MOLDING COMPOUND

(71) Applicant: Bauer Hockey Ltd., Blainville (CA)

(72) Inventors: Candide Deschenes, Saint-Jerome (CA); Edouard Rouzier, Montreal (CA); Mathieu Ducharme, Prevost (CA); Jean-Francois Corbeil, Prevost (CA)

(73) Assignee: Bauer Hockey, LLC, Exeter, NH (US)

(21) Appl. No.: 17/932,197

(22) Filed: Sep. 14, 2022

Related U.S. Application Data
(60) Provisional application No. 63/246,675, filed on Sep. 21, 2021.

(51) Int. Cl. A43B 13/18; B29D 35/12; B29D 35/14

(52) U.S. Cl. CPC A43B 13/18; B29D 35/122; B29D 35/142; B29K 2309/08

(57) ABSTRACT

A construct for a hockey skate outsole formed from layers of sheet molding compound material. The sheet molding compound material may be manufactured to have shorter average fiber lengths with random orientation in order to enhance the mechanical properties of the formed hockey skate outsole.

### CROSS-REFERENCE TO RELATED APPLICATION

This application claims priority to U.S. Provisional Patent Application No. 63/246,675, filed on Sep. 21, 2021, which is hereby incorporated by reference in its entirety.

### FIELD

The present disclosure relates generally to fabrication of molded structures. More particularly, aspects of this disclosure relate to hockey skate outsoles molded from a sheet molding compound material.

### BACKGROUND

Hockey skate outsoles may be made from multiple layers of fiber-reinforced tape that are molded together using epoxy to form an outsole structure. This molding process involves lengthy setup (draping) and curing times as a result of the use of the multiple layers of fiber-reinforced tape. Additionally, this molding process is ill-suited for complex geometries. Aspects of this disclosure relate to improved methods for production of a molded outsole with complex geometries.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of the disclosure herein may relate to fabrication of a formed hockey skate outsole structure. In one example, the formed hockey skate outsole structure may include forming a sheet molding compound material by introducing randomly oriented fiber strands in between layers of resin paste and solidifying the resultant composition into a flexible sheet. The sheet molding compound material may be cut into preform layers, and the preform layers may be positioned in a mold. The mold may be heated and cooled to produce a formed hockey skate outsole structure.

### BRIEF DESCRIPTION OF THE DRAWINGS

The present disclosure is illustrated by way of example and not limited in the accompanying figures in which like reference numerals indicate similar elements in which:

FIG. 1 depicts a perspective view of a hockey skate featuring an outsole structure manufactured using sheet molding compound (SMC) material according to one or more aspects described herein.

FIG. 2 schematically depicts a process for manufacturing a SMC material that may be used to manufacture hockey skate outsoles, according to one or more aspects described herein.

FIG. 3 depicts multiple layers of SMC material that have been cut into preform layers that approximate the geometry of a hockey skate outsole structure, according to one or more aspects described herein.

FIG. 4 depicts the hockey state outsole structure of FIG. 3 after all layers of the SMC material have been cut to a desired shape and layered in a manner ready to be positioned within a mold, according to one or more aspects described herein.

FIG. 5 depicts a front perspective view of the example hockey skate outsole manufactured using SMC material as shown in FIG. 1.

FIG. 6 depicts a plan view of one example hockey skate outsole manufactured using SMC material.

FIG. 6A depicts an isometric view of the example hockey skate outsole shown in FIG. 6.

FIG. 7 depicts a plan view of another example hockey skate outsole manufactured using SMC material.

FIG. 7A depicts an isometric view of the example hockey skate outsole shown in FIG. 7.

FIG. 8 depicts a plan view of another example hockey skate outsole manufactured using SMC material.

FIG. 8A depicts an isometric view of the example hockey skate outsole shown in FIG. 8.

FIG. 9 depicts a plan view of another example hockey skate outsole manufactured using SMC material.

FIG. 9A depicts an isometric view of the example hockey skate outsole shown in FIG. 9.

FIG. 10A depicts a perspective view of another example hockey skate outsole manufactured using SMC material.

FIG. 10B depicts another perspective view of the example hockey skate outsole shown in FIG. 10A.

### DETAILED DESCRIPTION

In the following description of various example structures, reference is made to the accompanying drawings, which form a part hereof, and in which are shown by way of illustration various embodiments in which aspects of the disclosure may be practiced. Additionally, it is to be understood that other specific arrangements of parts and structures may be utilized, and structural and functional modifications may be made without departing from the scope of the present disclosures. Also, while the terms “top” and “bottom” and the like may be used in this specification to describe various example features and elements, these terms are used herein as a matter of convenience, e.g., based on the example orientations shown in the figures and/or the orientations in typical use. Nothing in this specification should be construed as requiring a specific three-dimensional or spatial orientation of structures in order to fall within the scope of this invention.

Aspects of this disclosure relate to systems and methods for production of a hockey skate outsole using a sheet molding compound (SMC), otherwise referred to as bulk molding compound (BMC). Additionally, aspects of this disclosure may also be applied to production of additional sporting implements using SMC/BMC, among others. These additional sporting implements may include, among others, hockey sticks, as discussed in U.S. patent application Ser. No. 16/576,843, which is fully incorporated herein by reference, tennis rackets (or other types of sports rackets), baseball bats, lacrosse sticks, golf clubs, or field hockey sticks.

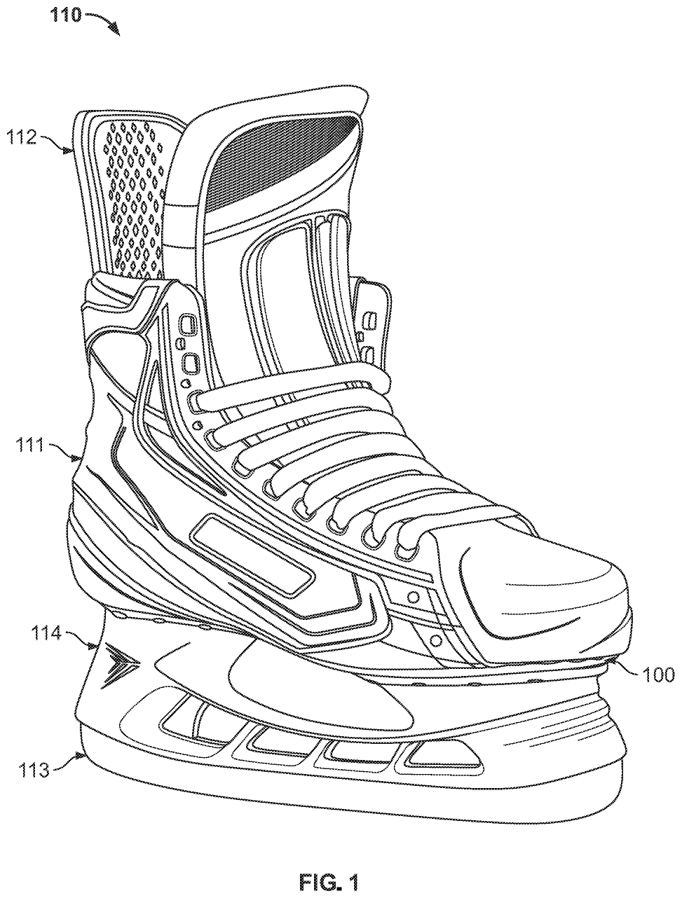

FIG. 1 depicts a perspective view of a hockey skate 110. In particular, the hockey skate 110 may include a standard leather or plastic boot 111 with a tendon guard 112 and a skate blade 113 affixed to a skate blade holder 114. The skate blade holder 114 may be connected or fastened to a hockey skate outsole structure 100 manufactured from an SMC compound.

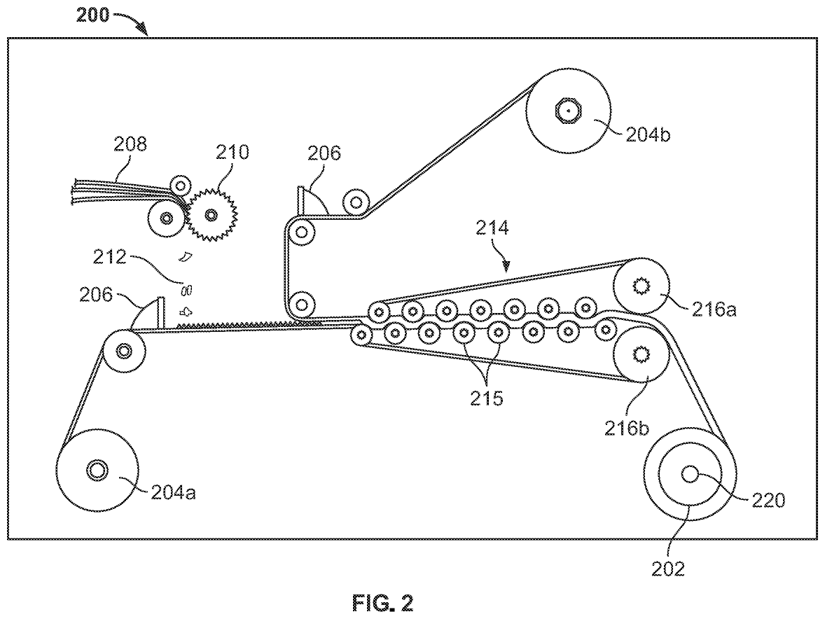

FIG. 2 schematically depicts a process 200 for manufacturing a sheet molding compound 202, which may be used to manufacture hockey skate outsoles. It is contemplated that the schematic process depicted in FIG. 2 may include additional or alternative processing steps, without departing from the scope of these disclosures. It is further contemplated that where these disclosures describe the use of a polymer, any polymer or elastomer may be used, without departing from the scope of these disclosures. Further, where one or more specific polymers are described, it is contemplated that additional or alternative polymer materials may be used in combination with or as alternatives to the specific polymers, without departing from the scope of these disclosures. Accordingly, elements 204a and 204b schematically depict rolls of a carrier film. The carrier films 204a and 204b may be polymeric or metallic sheets that act as a platform onto which a resin paste 206 may be applied. The resin paste 206 may be a form of synthetic resin, which may include a thermosetting polymer or another resin type. The resin paste 206 may be heated and applied to the carrier film rolls 204a and 204b as a viscous liquid. The depth of the resin paste 206 when applied to the carrier film rolls 204a and 204b may have any value. Consequently, the sheet molding compound 202 produced by compressing the first carrier film 204a against the second carrier film 204b may have any thickness, without departing from the scope of these disclosures.

A continuous fiber structure (or multiple fibers of a same or differing material type) 208 may be cut to a desired length by a chopper mechanism 210 and the cut lengths of fiber 212 may be applied to the soft resin paste 206 supported on the carrier film 204a. where described herein, a fiber may include carbon fibers, glass fibers, or Aramid material, among others. The cut fibers 212 may have any length values, or differing lengths, including random lengths, and may be applied to the resin paste 206 with random orientations. The compaction belt 214 may include a series of roller elements, of which roller elements 215 are two examples of a larger number of roller elements, configured to compress the layer of resin paste 206 carried on the first carrier film 204a against the layer of resin paste 206 carried on the second carrier film 204b. the compression may result in the formation of a single continuous sheet of sheet molding compound material 202 that entrains the randomly oriented fibers 212. This latter stage of the sheet molding compound manufacturing process may remove and recover the carrier film 204a and 204b on rolls 216a and 216b, before cooling and storing the finished sheet molding compound 202 on the depicted roller 220.

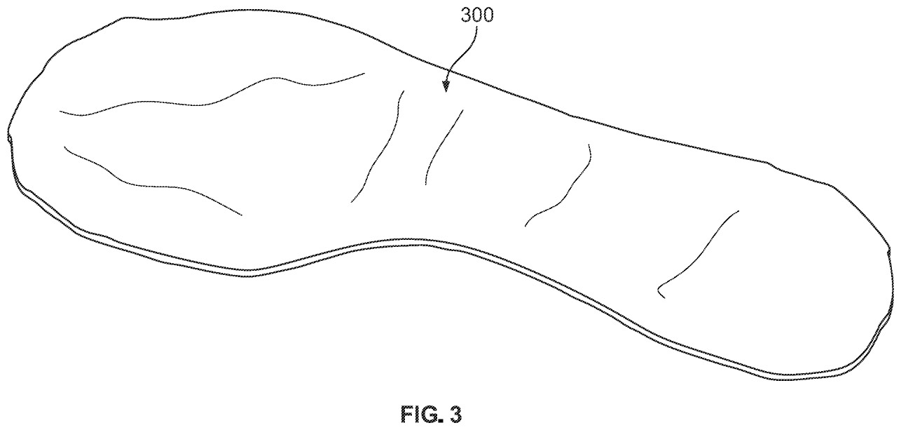

FIG. 3 depicts multiple layers of a sheet molding compound material that has been cut into preform layers that approximate the geometry of a hockey skate outsole structure. In the depicted example of FIG. 3, four layers of sheet molding compound material may be used to construct a hockey skate outsole preform 300 prior to molding. The multiple layers of sheet molding compound material may be configured to approximate the geometry of the hockey skate outsole structure 300. Alternatively, two interior layers (between the top and bottom layers) of sheet molding compound material may be configured with a different geometry than that of the top and bottom layers to provide added durability to one or more areas of a hockey skate outsole that may be intended to exhibit comparatively higher mechanical toughness. For example, interior layers of sheet molding compound material having circular, triangular, square, rectangular, trapezoidal or oval geometries, or combinations thereof, among others, may be used in addition to or as an alternative to a shape that approximates the geometry of hockey skate outsole structure 300. Similarly, the interior layers of sheet molding compound material may be configured with a comparatively higher thickness than that of the top and bottom layers. However, fewer than four or more than four layers may be used, without departing from the scope of these disclosures. Advantageously, the number of layers of sheet molding compound required to form a preform of a hockey skate outsole 300 may be less than a number of layers of pre-impregnated carbon layers or layers of fiber tape that may be used in alternative hockey skate outsole manufacturing processes. Consequently, the time required to cut, position, and mold the sheet molding compound material layers 302a-302d may be less than that required for a hockey skate outsole manufactured using layers of fiber tape. As such, the use of the sheet molding compound material may reduce the manufacturing cost of a hockey skate outsole when compared with manufacturing processes that only use layers of fiber tape. In one example, the number of layers of sheet molding compound material may be approximately equal to, or more than, an order of magnitude less than a number of layers of fiber tape required to construct a similarly sized hockey skate outsole. In one specific example, a hockey skate outsole constructed using conventional fiber tape may use approximately 40 layers of fiber tape, compared with 4 layers of sheet molding compound material used in the hockey skate outsole preform 300.

In one example, the hockey skate outsole preform 300 may use a foam core onto which the sheet molding compound material layers are applied. The foam used for the core may include any foam type. In another example, a core of the hockey skate outsole preform 300 may be made from one or more layers of sheet molding compound material. In yet another example, a core of a hockey skate outsole preform 300 may include a foam core wrapped with a pre-impregnated carbon layers/fiber tape material. These core structures may be used in any example of a hockey skate outsole that uses sheet molding compound material, such as outsole structures 600, 700, 800, and 900, described in further detail in the proceeding disclosure.

Additionally or alternatively, two or more different types of sheet molding compound material may be used in the hockey skate outsole preform 300. The different types of sheet molding compound material may have different mechanical properties, once molded, that result from, among others, differing material thicknesses, differing resins used to entrain the fibers, differing fiber materials, and/or differing average fiber lengths, or combinations thereof. In one example, the top and bottom layers of the sheet molding compound material may use a first sheet molding material type that has a first average fiber length, and the interior layers (between the top and bottom layers) of sheet molding compound material may use a second sheet molding material type that has a second average fiber length. In one example, the first average fiber length may be 10 mm or less, and the second average fiber length may be 20 mm or more, or 25.4 mm or more. It is noted that these values are for illustrative purposes only, and may be swapped in the example depicted in FIG. 3 Additionally, the average fiber length of fibers entrained within a sheet molding compound material, as described herein, may measure approximately 5 mm, 10 mm, 15 mm, 20 mm, 25 mm, 30 mm, 35 mm, or 40 mm or more. Further, it is contemplated that any fiber lengths may be used in the sheet molding compound materials described herein, or combinations of different fiber lengths, without departing from the scope of these disclosures. In one example, a sheet molding compound material with a longer fiber length may be used to provide added durability to one or more areas of a hockey skate outsole that may be intended to exhibit comparatively higher mechanical toughness.

In one example, a first sheet molding compound material having randomly oriented fibers may be positioned at areas/regions of a hockey skate outsole structure that are subjected to comparatively higher and/or more frequent mechanical stresses. A second sheet molding compound material having randomly oriented fibers that are shorter than those of the first sheet molding compound material may be positioned at areas/regions of a hockey skate outsole structure that are subjected to comparatively lower and/or less frequent mechanical stresses or none or minimal amounts of fibers can be provided in the low stress areas. For example, a sheet molding compound material with comparatively longer average fiber lengths may be used in a forefoot region, midsole region, and/or heel region of outsoles 600, 700, 800, 900, and 1000 (described in further detail in the proceeding disclosure) while the remainder of the outsole may include shorter fibers or minimal or no random fibers at all.

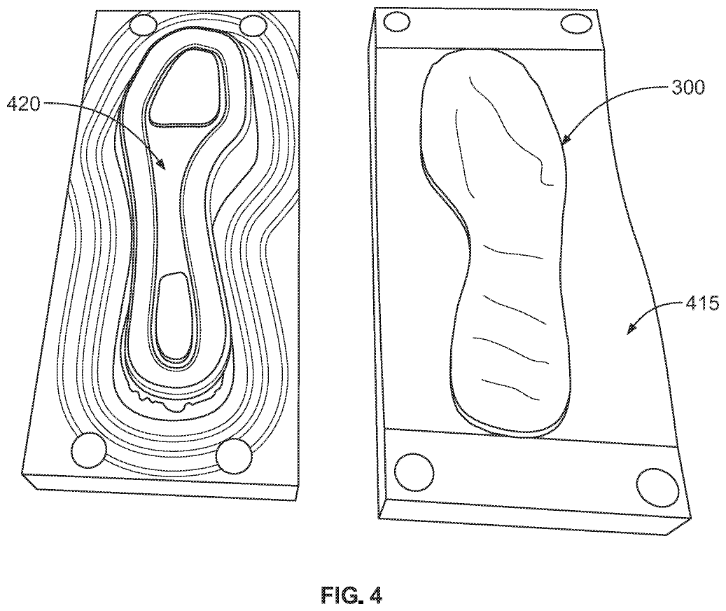

FIG. 4 depicts the hockey skate outsole preform 300 within a mold component 415. The mold component 415 may be configured to impart a desired hockey skate outsole curvature and final geometry to the outsole preform 300. Accordingly, the mold component 415 may be constructed from a metal, alloy, or another material capable of withstanding the high temperature and pressure associated with molding of the preform 300. Further, it is contemplated that the mold component 415 may be one half of a female-female type mold, or one half of a female-male type mold, without departing from the scope of these disclosures. Mold component 420 may be the male component of a female-male type mold and may mate with mold component 415 to impart a desired hockey skate outsole curvature and final geometry to the outsole preform 300. It is contemplated that a mold release agent material, and/or a mechanical release mechanism may be used to remove the molded hockey skate outsole from the mold cavity.

The hockey skate outsole preform 300 may be heated and cooled within the mold components 415 and 420. Additionally, the mold component 420 may apply pressure to the preform 300 in order to impart a desired shape to the formed hockey skate outsole. It is contemplated that any pressure and temperature values may be used, without departing from the scope of these disclosures. Advantageously, the use of sheet molding compound material in the hockey skate outsole preform 300 may decrease the curing time to mold the preform 300 into a finished hockey skate outsole. In one example, the curing time may be reduced by a factor of 10 or more when compared to a hockey skate outsole constructed using layers of fiber tape, and without using sheet molding compound material. In one specific example, the hockey skate outsole preform 300 may be cured and removable from the mold components 415 and 420 in less than 20 minutes, less than 10 minutes, or less than 5 minutes from a start of a heating and cooling sequence of the mold components 415 and 420. It is further contemplated that the mold components 415 and 420 may be heated and cooled within any suitable device or environment, without departing from the scope of these disclosures.

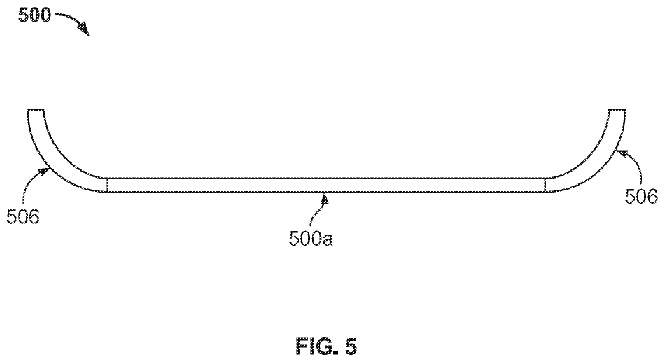

FIG. 5 depicts an example hockey skate outsole structure 500 that may be constructed using one or more layers of sheet molding compound material. Outsole structure 500 includes a sole plate 500a constructed using one or more layers of sheet molding compound material. Sole plate 500a may include support wings 506 integrally molded to the sole plate 500a and extending upwards therefrom. In one example, at least one support wing 506 may be integrally molded to the sole plate 500a only on a first side, i.e., the side of the sole plate 500a that corresponds to the arches of a user's feet, of the sole plate 500a. In another example, at least one support wing 506 may be integrally molded to the sole plate only on a second side (opposite the first side) of the sole plate 500a. In another example, two support wings 506 may be integrally molded to both the first and second sides of the sole plate 500a. Support wings 506 may be integrally molded along various regions of the sole plate. For example, support wings 506 may be configured along a forefoot region of the sole plate 500a or a midsole region of the sole plate 500a. Additionally and/or alternatively, support wings 506 may be configured to extend along both the forefoot region and midsole region of the sole plate 500a.

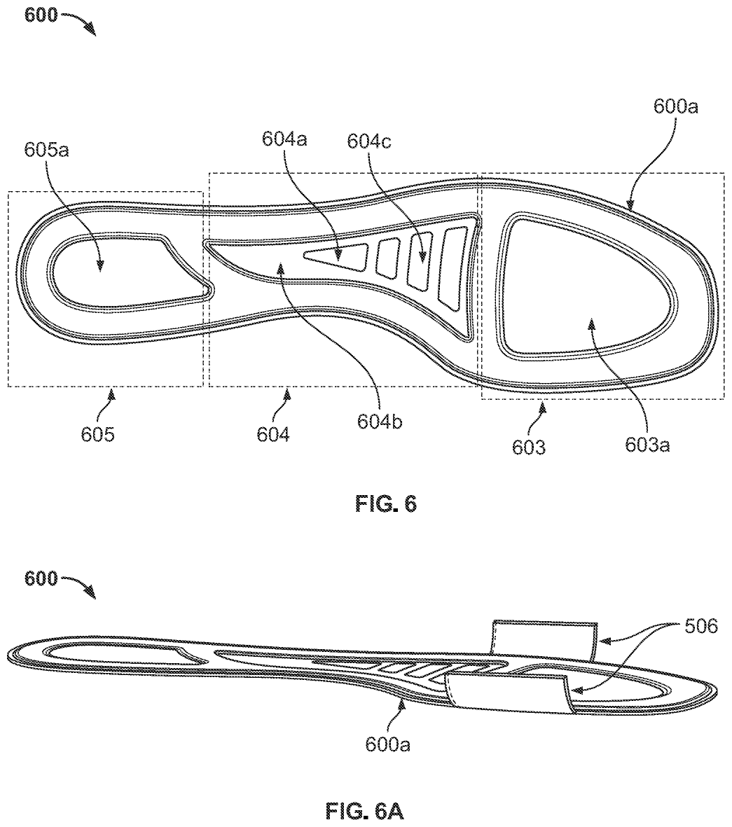

FIG. 6 depicts an example hockey skate outsole structure 600 that may be constructed using one or more layers of sheet molding compound material. As depicted, the hockey skate outsole structure 600 includes a sole plate 600a. The sole plate 600a may also include a forefoot region 603 and a forefoot aperture 603a. The sole plate 600a may also include a midsole region 604. The midsole region 604 may further include a plurality of midsole apertures 604a, a recessed portion 604b, and support ribs 604c. The sole plate 600a may additionally include a heel region 605 and a heel aperture 605a.

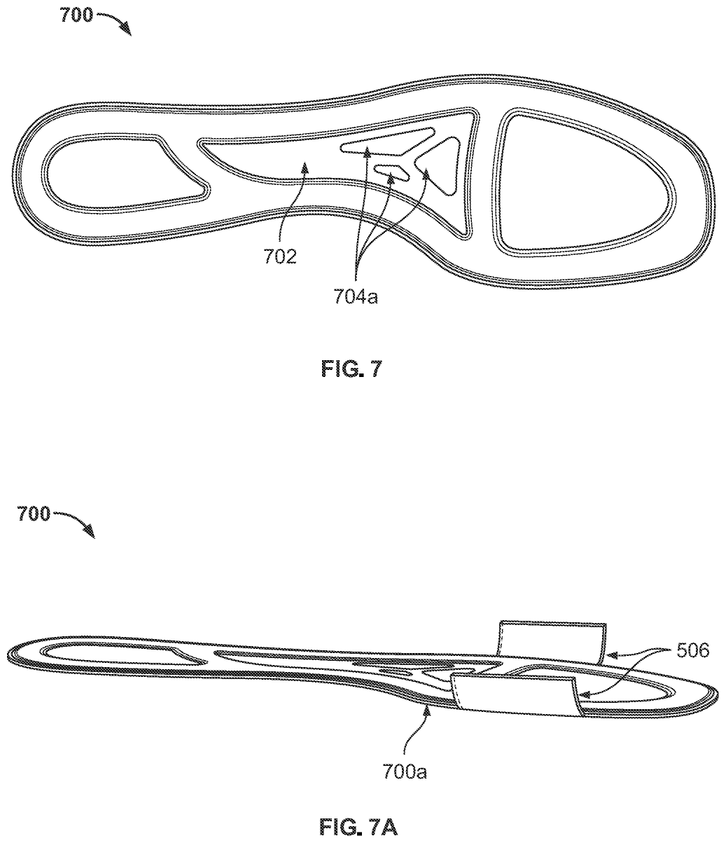

The depicted geometries of the apertures 603a, 604a, and 605a represent merely one example of possible geometries. For example, apertures having circular, triangular, square, rectangular, trapezoidal or oval geometries, or combinations thereof, among others, may be used in addition to or as an alternative to apertures 603a, 604a, and 605a. For example, as depicted in FIG. 7, hockey skate outsole structure 700 may have a plurality of midsole apertures 704a with triangular geometries.

In one example, the apertures 603a, 604a, and 605a may be formed by removing material from one or more outer layers of sheet molding compound material used to form the hockey skate outsole structure 600. This material may be removed using any applicable material removal process, such as, among others, die-cutting, stamping, laser-cutting, or milling, or combinations thereof. Additionally, or alternatively, one or more internal (non-visible) sheet molding compound material layers of the hockey skate outsole structure 600 may include cutout features similar to those features 603a, 604a, and 605a. Advantageously, the apertures 603a, 604a, and 605a may reduce the mass of the hockey skate outsole structure 600 and/or provide variable mechanical stiffness at predetermined areas of the outsole structure 600. Similarly, a recessed midsole portion 604b may also formed by die-cutting, stamping, laser-cutting, or milling, or combinations thereof, which may also reduce the mass of the hockey skate outsole structure 600 and/or provide variable mechanical stiffness at predetermined areas of the outsole structure 600. Support ribs 604c may be configured to augment the mechanical properties of the outsole structure 600. For example, support ribs 604c may adjust the rigidity/flexibility of the outsole 600, among others. In another example, support ribs may be included within the hockey skate outsole structure 600 such that they are not visible on an external surface.

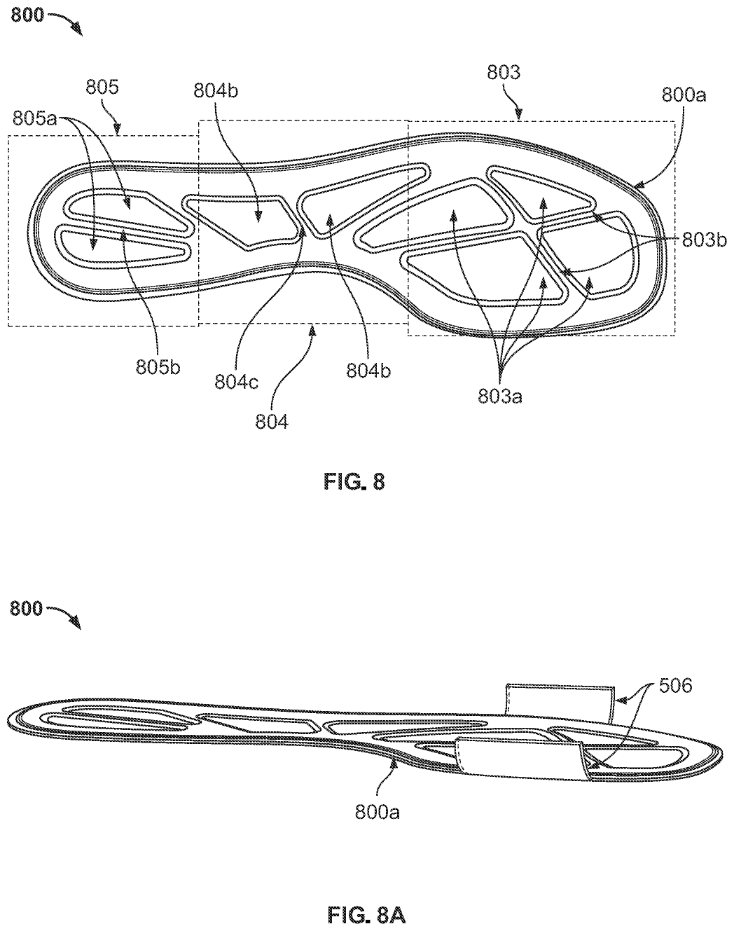

As noted, utilizing one or more layers of SMC material may allow for improved methods for production of a molded outsole with complex geometries. The present disclosure may include various combinations of apertures and integrally molded support ribs, or lack thereof. For example, as depicted in FIG. 8, hockey skate outsole structure 800 may include a sole plate 800a. Sole plate 800a may include a forefoot region 803, forefoot apertures 803a, and forefoot support ribs 803b. The sole plate 800a may also include a midsole region 804. The midsole region 804 may further include recessed midsole portions 804b and 804c divided by support rib 804c. The recessed midsole portions 804b and 804c may be integral to midsole region 804. Recessed midsole portions having circular, triangular, square, rectangular, trapezoidal or oval geometries, or combinations thereof, among others, may be used in addition to or as an alternative to recessed midsole portions 804b and 804c. For example, as depicted in FIG. 7, hockey skate outsole structure 700 may have at least one recessed midsole portion 702 with a roughly triangular geometry. Referring again to FIG. 8, the sole plate 800a may additionally include a heel region 805 and heel apertures 805a divided by a heel support rib 805b.

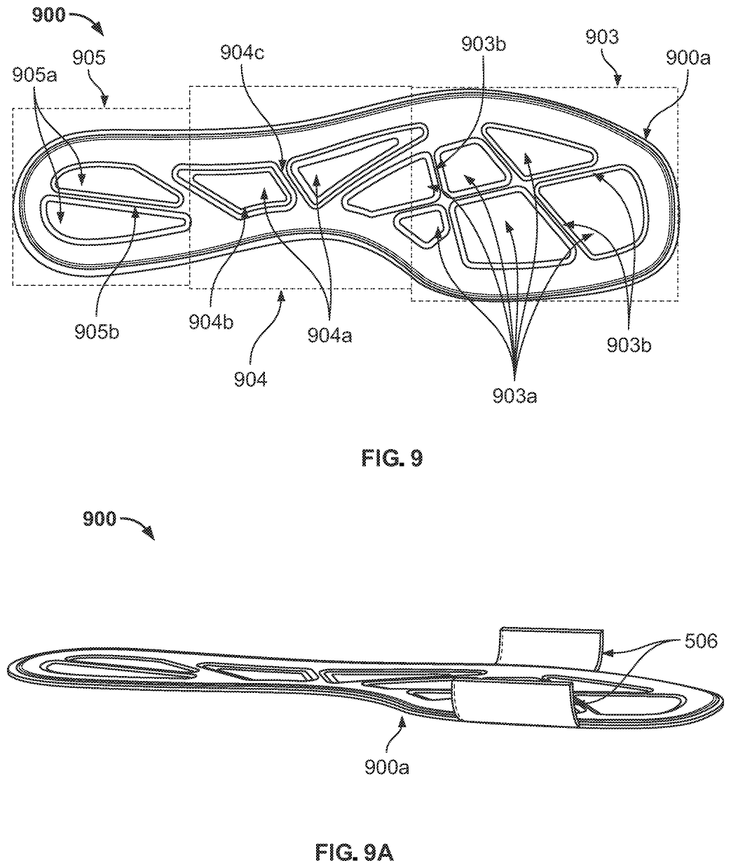

FIG. 9 depicts another example hockey skate outsole structure 900 that may be constructed using one or more layers of sheet molding compound material. Hockey skate outsole structure 900 may include a sole plate 900a. Sole plate 900a may include a forefoot region 903, forefoot apertures 903a, and forefoot support ribs 903b. Sole plate 900a also may include a midsole region 904 that may include midsole apertures 904a that extend substantially to the perimeter of recessed midsole portions 904b. Midsole region 904 may also include at least one midsole support rib 904c that divides midsole apertures 904a. Sole plate 900a may additionally include a heel region 905 and heel apertures 905a divided by a heel support rib 905b.

Outsole structures 600, 700, 800, and 900 may also include a plurality of support wings 506 integrally molded to respective sole plates 600a, 700a, 800a, and 900a and extending upwards therefrom, as depicted in FIGS. 6A, 7A, 8A, and 9A, respectively. In one example, at least one support wing 506 may be integrally molded to the sole plates 600a, 700a, 800a, and 900a only on a first side, i.e., the sides of the sole plates 600a, 700a, 800a, and 900a that correspond to the arches of a user's feet. In another example, at least one support wing 506 may be integrally molded to the sole plate only on a second side (opposite the first side) of the sole plates 600a, 700a, 800a, and 900a. In another example, two support wings 506 may be integrally molded to both the first and second sides of the sole plates 600a, 700a, 800a, and 900a. Support wings 506 may be integrally molded along various regions of the sole plates. For example, support wings 506 may be configured to extend only along the respective forefoot regions, only along the respective midsole regions, or only along the respective heel regions of the sole plates 600a, 700a, 800a, and 900a. Additionally and/or alternatively, support wings 506 may be configured to extend along both the respective forefoot regions and midsole regions of the sole plates 600a, 700a, 800a, and 900a.

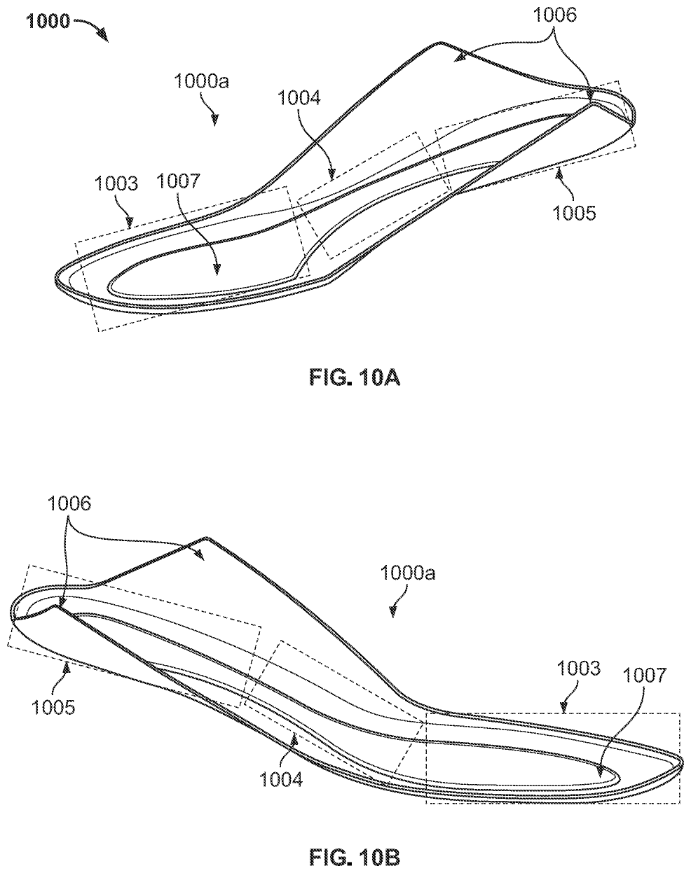

FIGS. 10A and 10B depict an example hockey skate outsole structure 1000 that may be constructed using one or more layers of sheet molding compound material. Hockey skate outsole structure 1000 may include a sole plate 1000a.

Sole plate 1000a may include a forefoot region 1003, a midsole region 1004, and a heel region 1005. Sole plate 1000a may include a plurality of support wings 1006 integrally molded to the sole plate 1000a. In one example, at least one support wing 1006 may be integrally molded to the sole plate 1000a only on a first side, i.e., the sides of the sole plate 1000a that correspond to the arches of a user's feet, of the sole plate 1000a. In another example, at least one support wing 1006 may be integrally molded to the sole plate only on a second side (opposite the first side) of the sole plate 1000a. In another example, two support wings 1006 may be integrally molded to both the first and second sides of the sole plate 1000a. Support wings 1006 may be integrally molded along various regions of the sole plate 1000a. For example, support wings 1006 may be configured to extend along and upwards from the forefoot region 1003, only along and upwards from the midsole region 1004, or only along and upwards from the heel region 1005 of the sole plate 1000a. Additionally and/or alternatively, support wings 1006 may be configured to extend along and upwards from both the forefoot region and midsole region of the sole plate 1000a, or upwards from and long both the midsole region and the heel region of the sole plate 1000a. Support wings 1006 may be formed from a sheet molding compound material.

Support wings 1006 may be configured in a variety of shapes. For example, support wings 1006 having circular, ellipsoidal, arcuate, triangular, square, rectangular, trapezoidal or oval geometries, or combinations thereof, among others, may be used in addition to or as an alternative to the support wings 1006 as depicted in FIGS. 10A and 10B.

Sole plate 1000a may include a reinforced structure 1007. In this example, additional layers of sheet molding compound material may be positioned at an area of the sole plate 1000a intended to exhibit comparatively higher mechanical toughness. In one example, reinforced structure 1007 may extend continuously from the heel region 1005 to the forefoot region 1003 along a medial axis of sole plate 1000a. In another example, reinforced structure 1007 may be confined to extend only through substantially all of the forefoot region 1003, only through substantially all of the midsole region 1004, or only through substantially all of the heel region 1005, or any combination thereof.

In one example, a formed hockey skate outsole structure may be fabricated using a method that includes forming a sheet molding compound material. The sheet molding compound material may be formed by introducing randomly oriented fiber strands in between layers of resin paste. The sheet molding compound material may be solidified to result in a composite in the form of a flexible sheet. The sheet molding compound material may be cut into preform layers and the preform layers may be positioned within a mold. The mold may be heated and cooled and the cured hockey skate outsole structure may be removed from the mold.

In one example, the fiber strands within the sheet molding compound material may measure at least 10 mm in length, or at least 25.4 mm in length.

In another example, the method of fabricating a formed hockey skate outsole structure may additionally include positioning a foam core between a selected two of the preform layers of the sheet molding compound material in the mold. As such, the foam core may be integrally molded within the hockey skate outsole structure.

In another example, a first sheet molding compound material may have a first average fiber strand length of fibers that are randomly oriented within the first sheet molding compound material and a second sheet molding compound material may have a second average fiber strand length of fibers that are randomly oriented within the second sheet molding compound material. The first and second sheet molding compound materials may be cut to form the preform layers such that a molded hockey skate outsole structure may include a first portion that has fibers with a first average strand length and a second portion that has fibers with a second average strand length.

In one example, the first average fiber strand length may be shorter than the second average fiber strand length, and the second sheet molding compound material (and preform layers made therefrom) may be positioned at an area of the outsole intended to exhibit comparatively higher mechanical toughness.

In one example, a hockey skate outsole structure may be formed from less than five preform layers of sheet molding compound material.

The construction of a molded hockey skate outsole structure may additionally include positioning a layer of fiber tape in a mold with preform layers of sheet molding compound material. The fiber tape may be pre-impregnated with resin and have unidirectional fibers.

The fibers of the sheet molding compound material may include carbon fibers or glass fibers, among others.

In one example, the heating and cooling of the mold to a time when the molded hockey skate outsole structure may be removed from the mold may be completed in less than 10 minutes.

In another example, a hockey skate outsole structure may be formed by a method that includes forming a first sheet molding compound material by introducing randomly oriented fiber strands having a first average length in between layers of resin paste, and solidifying a resultant composite into a first flexible sheet. A second sheet molding compound material may be formed by introducing randomly oriented fiber strands having a second average length, longer than the first average length, in between layers of resin paste and solidifying a resultant composition into a second flexible sheet. The first and second sheet molding compound materials may be cut into preform layers, and the preform there is positioned in a mold. The mold may subsequently be heated and cooled, and a formed hockey skate outsole structure may be removed from the mold.

In one example, the hockey skate outsole apparatus may be molded and removable from the mold in less than 10 minutes.

An outsole structure may comprise a sole plate formed from a sheet molding compound material. The outsole structure may further comprise a forefoot structure integrally molded to the sole plate. The forefoot structure may comprise at least one forefoot aperture that may be defined by a contour of the forefoot structure and that may extend over a majority of the forefoot structure. The at least one forefoot aperture may be divided by at least one forefoot support rib. The outsole structure may further comprise a midsole structure integrally molded to the sole plate. The midsole structure may comprise at least one midsole support rib that is integrally molded to the sole plate and transverses a recessed portion of the sole plate. The outsole structure may comprise a heel structure integrally molded to the sole plate, comprising at least one heel aperture that extends over a majority of the heel structure and is divided by at least one heel support rib having a first end integrally molded to the heel structure distal to the midsole structure and a second end integrally molded to the heel structure proximal to the midsole structure. The outsole structure may further comprise at least one support wing structure integrally molded to and extending upwards from the sole plate. The sole plate may be molded from one preform layer of sheet molding compound material. The one preform layer may comprise a flexible sheet of solidified resin paste impregnated with randomly oriented fiber strands. The fiber strands may measure at least 10 mm in length. The fiber strands may measure at least 25.4 mm in length. The fiber strands may comprise carbon fibers. The fiber strands may comprise glass fibers. The sole plate may be molded from at least a first and a second preform layer of sheet molding compound material, the first preform layer comprising a flexible sheet of solidified resin paste impregnated with randomly oriented fiber strands having a first average length and the second preform layer comprising a flexible sheet of solidified resin paste impregnated with randomly oriented fiber strands having a second average length longer than the first. The first average length of the fiber strands may be less than 10 mm and the second average length of the fiber strands may be greater than 20 mm.

A method of fabricating a formed outsole structure may comprise forming a sheet molding compound material by introducing randomly oriented fiber strands in between layers of resin paste and solidifying a resultant composite into a flexible sheet, cutting the sheet molding compound material into at least one preform layer, positioning the at least one preform layer in a mold, heating and cooling the mold, removing a formed outsole structure from the mold. An outsole structure may be formed according to the above method. The outsole structure may comprise a sole plate. The sole plate may comprise a forefoot structure integrally molded to the sole plate. The forefoot structure may comprise at least one forefoot aperture that may be defined by the contour of the forefoot structure and may extend across at least a majority of the forefoot structure. The sole plate may further comprise a midsole structure integrally molded to the sole plate. The midsole structure may comprise a recessed midsole portion. The sole plate may further comprise a heel structure integrally molded to the sole plate. The heel structure may comprise at least one heel aperture that is defined by the contour of the heel structure and extends across at least a majority of the heel structure. The sole plate may further comprise at least one support wing structure integrally connected to and extending upwards from the sole plate. The fiber strands may measure at least 10 mm in length. The fiber strands may measure at least 25.4 mm in length. The fiber strands may comprise carbon fibers. The fiber strands may comprise glass fibers.

A method of fabricating a formed outsole structure may comprise the steps of: forming a first sheet molding compound material by introducing randomly oriented fiber strands having a first average length in between layers of resin paste and solidifying a resultant composite into a first flexible sheet; forming a second sheet molding compound material by introducing randomly oriented fiber strands having a second average length, longer than the first average length, in between layers of resin paste and solidifying a resultant composite into a second flexible sheet; cutting the first sheet molding compound material into a first preform layer; cutting the second sheet molding compound material into a second preform layer; positioning the first and second preform layers in a mold; heating and cooling the mold; and removing a formed outsole structure from the mold. The method may further comprise positioning a foam core between a selected two of the preform layers of the sheet molding compound material in the mold to be integrally molded within the hockey skate outsole structure. The second preform layers may be positioned at areas of the outsole structure intended to exhibit comparatively higher mechanical toughness. An outsole structure may be formed according to the above method. The outsole structure may comprise a sole plate. The sole plate may comprise a forefoot structure integrally molded to the sole plate. The forefoot structure may comprise at least one forefoot aperture that may be defined by the contour of the forefoot structure and may extend over at least a majority of the forefoot structure. The sole plate may comprise a midsole structure integrally molded to the sole plate. The midsole structure may comprise a recessed midsole portion. The sole plate may comprise a heel structure integrally molded to the sole plate. The heel structure may comprise a heel aperture that may be defined by the contour of the heel structure and may extend across at least a majority of the heel structure. The sole plate may further comprise at least one support wing structure integrally molded to and extending upwards from the sole plate on a first side of the sole plate at the midsole region.

An outsole structure may comprise a sole plate formed from a sheet molding compound material. The sole plate may comprise a first side, a second side, a forefoot region, a midsole region, and a heel region. The outsole structure may further comprise a first support wing integrally connected to and extending upwards from the sole plate. The first support wing may be integrally connected to and extend upwards from the first side of the sole plate. The sole plate may further comprise a second support wing integrally connected to and extending upwards from the second side of the sole plate. The first and second support wings may be integrally connected to and extend upwards from the sole plate at the heel region. The first and second support wings may be integrally connected to and extend upwards from the sole plate at the midsole region. The first and second support wings may be integrally connected to and extend upwards from the sole plate at the forefoot region. The first support wing may be formed from a sheet molding compound material. The sole plate may further comprise a reinforced structure integrally molded to the sole plate.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

1. An outsole structure comprising:
a sole plate formed from a sheet molding compound material, further comprising:
a forefoot structure integrally molded to the sole plate, comprising at least one forefoot aperture that is defined by a contour of the forefoot structure and extends over a majority of the forefoot structure, the at least one forefoot aperture being divided by at least one forefoot support rib;
a midsole structure integrally molded to the sole plate, the midsole structure comprising at least one midsole support rib that is integrally molded to the sole plate and transverses a recessed portion of the sole plate;
a heel structure integrally molded to the sole plate, the heel structure comprising at least one heel aperture that extends over a majority of the heel structure and is divided by at least one heel support rib having a first end integrally molded to the heel structure distal to the midsole structure and a second end integrally molded to the heel structure proximal to the midsole structure; and
at least one support wing structure integrally molded to and extending upwards from the sole plate.

2. The outsole structure of claim 1, wherein the sole plate is molded from one preform layer of sheet molding compound material, the one preform layer comprising a flexible sheet of solidified resin paste impregnated with randomly oriented fiber strands.

3. The outsole structure of claim 2, wherein the fiber strands measure at least 10 mm in length.

4. The outsole structure of claim 3, wherein the fiber strands measure at least 25.4 mm in length.

5. The outsole structure of claim 2, wherein the fiber strands comprise carbon fibers.

6. The outsole structure of claim 2, wherein the fiber strands comprise glass fibers.

7. The outsole structure of claim 1, wherein the sole plate is molded from at least a first and a second preform layer of sheet molding compound material, the first preform layer comprising a flexible sheet of solidified resin paste impregnated with randomly oriented fiber strands having a first average length and the second preform layer comprising a flexible sheet of solidified resin paste impregnated with randomly oriented fiber strands having a second average length longer than the first.

8. The outsole structure of claim 7, wherein the first average length is less than 10 mm and the second average length is greater than 20 mm.

9. A method of fabrication comprising:
forming a sheet molding compound material by introducing randomly oriented fiber strands in between layers of resin paste and solidifying a resultant composite into a flexible sheet;
cutting the sheet molding compound material into at least one preform layer;
positioning the at least one preform layer in a mold;
heating and cooling the mold; and
removing an outsole structure from the mold.

10. An outsole structure formed according to the method of claim 9, further comprising:
a sole plate further comprising:
a forefoot structure integrally molded to the sole plate, the forefoot structure comprising at least one forefoot aperture that is defined by the contour of the forefoot structure and extends across at least a majority of the forefoot structure;
a midsole structure integrally molded to the sole plate, the midsole structure comprising a recessed midsole portion; and
a heel structure integrally molded to the sole plate, the heel structure comprising at least one heel aperture that is defined by the contour of the heel structure and extends across at least a majority of the heel structure.

11. An outsole structure according to claim 10, wherein the sole plate further comprises at least one support wing structure integrally connected to and extending upwards from the sole plate.

12. The method of claim 9, wherein the fiber strands measure at least 10 mm in length.

13. The method of claim 12, wherein the fibers strands measure at least 25.4 mm in length.

14. The method of claim 9, wherein the fiber strands comprise carbon fibers.

15. The method of claim 9, wherein the fiber strands comprise glass fibers.

16. A method of fabricating an outsole structure, comprising the steps of:
forming a first sheet molding compound material by introducing randomly oriented fiber strands having a first average length in between layers of resin paste and solidifying a resultant composite into a first flexible sheet;
forming a second sheet molding compound material by introducing randomly oriented fiber strands having a second average length, longer than the first average length, in between layers of resin paste and solidifying a resultant composite into a second flexible sheet;
cutting the first flexible sheet into a first preform layer;
cutting the second flexible sheet into a second preform layer;
positioning the first and second preform layers in a mold;
heating and cooling the mold; and
removing an outsole structure from the mold.

17. The method of claim 16, further comprising:
positioning a foam core between a selected two of the preform layers of the sheet molding compound material in the mold to be integrally molded within the outsole structure.

18. The method of claim 16, wherein the second preform layers are positioned at areas of the outsole structure intended to exhibit comparatively higher mechanical toughness.

19. An outsole structure formed according to the method of claim 16, further comprising:
a sole plate, further comprising:
a forefoot structure integrally molded to the sole plate comprising at least one forefoot aperture that is defined by the contour of the forefoot structure and extends over at least a majority of the forefoot structure;
a midsole structure integrally molded to the sole plate, the midsole structure comprising a recessed midsole portion; and
a heel structure integrally molded to the sole plate, the heel structure comprising a heel aperture that is defined by the contour of the heel structure and extends across at least a majority of the heel structure;

20. An outsole structure according to claim 19, wherein the sole plate further comprises at least one support wing structure integrally molded to and extending upwards from the sole plate on a first side of the sole plate at the midsole region.

21. An outsole structure comprising:
a sole plate formed from a sheet molding compound material, further comprising:
a first side, a second side, a forefoot region, a midsole region, and a heel region; and
a first support wing integrally connected to and extending upwards from the sole plate.

22. The outsole structure according to claim 21, wherein the first support wing is integrally connected to and extends upwards from the first side of the sole plate, the sole plate further comprising a second support wing integrally connected to and extending upwards from the second side of the sole plate.

23. The outsole structure according to claim 22, wherein the first and second support wings are integrally connected to and extend upwards from the sole plate at the heel region.

24. The outsole structure according to claim 22, wherein the first and second support wings are integrally connected to and extend upwards from the sole plate at the midsole region.

25. The outsole structure according to claim 22, wherein the first and second support wings are integrally connected to and extend upwards from the sole plate at the forefoot region.

26. The outsole structure according to claim 21, wherein the first support wing is formed from a sheet molding compound material.

27. The outsole structure according to claim 21, wherein the sole plate further comprises a reinforced structure integrally molded to the sole plate.
